(19) United States
(12) Patent Application Publication
(10) Pub. No.: US 2017/0194712 A1
(43) Pub. Date: Jul. 6, 2017

(54) Antenna Match Tuning

(71) Applicant: Disruptive Technologies Research AS, Radal (NO)

(72) Inventors: Lars-Tore Skiftesvik, Bones (NO); Karl Martin Gjertsen, Fana (NO)

(73) Assignee: Disruptive Technologies Research AS, Radal (NO)

(21) Appl. No.: 15/400,431

(22) Filed: Jan. 6, 2017

Related U.S. Application Data
(60) Provisional application No. 62/275,359, filed on Jan. 6, 2016.

(51) Int. Cl. H01Q 9/04; H04B 1/3827; H04B 17/10; H01Q 1/38; H01Q 3/24; H01Q 1/24; H01Q 1/48

(52) U.S. Cl. CPC H01Q 9/0442; H01Q 1/24; H04B 1/3833; H01Q 1/48; H01Q 1/38; H01Q 3/247; H04B 17/102

(57) ABSTRACT

A method of tuning antenna match is provided. The method may include providing a matching network of inductors and capacitors configured to match an impedance of an antenna, monitoring a voltage of the matching network, and adjusting an effective value of one or more of the inductors and the capacitors of the matching network when the voltage indicates a decrease in match quality. A radio frequency (RF) device is also provided. The RF device may include a ground layer defining a perimeter thereabout and having a ground pattern therein, a device circuit disposed on the ground pattern and within the perimeter, and an antenna coupled to the device circuit and disposed at least partially along the perimeter about the ground layer.

### TECHNICAL FIELD

The present disclosure relates generally to radio frequency (RF) devices, and more particularly, to design and impedance tuning techniques for antennas in small electrical devices.

### BACKGROUND

With growing interests in providing wireless products or solutions, the drive to improve radio frequency (RF) devices also continues to grow. One of the areas of improvements concerns the size of the RF devices. Especially within the realm of Internet of Things (IoT), for instance, there are substantial advantages to be gained from being able to provide smaller and more miniaturized RF devices. However, miniaturizing RF devices also comes with its challenges. One general concern is that miniaturizing the RF device entails miniaturizing the antenna enclosed within the RF device, which may adversely affect radio performance, or at least render the radio performance more susceptible to various forms of distortion.

In one respect, while smaller antennas may be made to perform effectively at a selected frequency in a defined environment, such solutions are very sensitive to change of both frequency and the properties of the local environment, which is especially important in dealing with small wireless devices. In another respect, radio performance relies substantially on matching the impedance of the antenna, but such matching can only support very narrow frequency intervals with smaller antennas. Still further, making a smaller antenna also subjects the antenna to much more adverse influence by surrounding objects which may enter the near field of the antenna. Such interference can negatively impact the electromagnetic properties, radiation patterns, efficiencies, matching conditions, or other attributes related to radio performance.

The present disclosure is directed at addressing one or more of the deficiencies and disadvantages set forth above. However, it should be appreciated that the solution of any particular problem is not a limitation on the scope of this disclosure or of the attached claims except to the extent expressly noted.

### SUMMARY OF THE DISCLOSURE

In one aspect of the present disclosure, a method of tuning antenna match is provided. The method may include providing a matching network, normally of inductors and capacitors, configured to match an impedance of an antenna, monitoring a voltage or other performance indicator of the matching network, and adjusting an effective value of one or more of the components of the matching network, until the indicator value shows optimal or acceptable match quality.

In another aspect of the present disclosure, a system for tuning a radio frequency (RF) device having a power amplifier, a tunable matching network with match indicator, and an antenna is provided. The tuning system may include a matching network coupled between the power amplifier and the antenna, and a controller having a measurement module and an tuner module in communication with the matching network. The measurement module may be configured to monitor a voltage or other performance indicator of the matching network, and the tuner module may be configured to adjust the effective value of the matching network when the controller activates change to arrive at desirable match quality.

In yet another aspect of the present disclosure, an RF device is provided. The RF device may include a ground layer defining a perimeter thereabout and having a ground pattern therein, a device circuit disposed on the ground layer and within the perimeter, and an antenna coupled to the device circuit and disposed at least partially along the perimeter about the ground layer.

These and other aspects and features will be more readily understood when reading the following detailed description in conjunction with the accompanying drawings.

### BRIEF DESCRIPTION OF THE DRAWINGS

FIG. 1 is a diagrammatic view of one exemplary tuning system for a small radio frequency (RF) device of the present disclosure;

FIG. 2 is a flow diagram of one exemplary scheme or method of tuning a matching network for an antenna of an RF device;

FIG. 3 is a perspective view of one exemplary antenna that may be used with the tuning system and the RF device of the present disclosure;

FIG. 4 is a top plan view of the exemplary antenna of FIG. 3;

FIG. 5 is a top plan view of the ground pattern and antenna of FIG. 3;

FIG. 6 is a perspective view of the ground pattern and antenna of FIG. 3;

FIG. 7 is an enlarged, perspective view of a section of the antenna of FIG. 3; and

FIG. 8 is a diagrammatic view of an embodiment of a tunable matching network for the tuning system of FIG. 1.

While the following detailed description is given with respect to certain illustrative embodiments, it is to be understood that such embodiments are not to be construed as limiting, but rather the present disclosure is entitled to a scope of protection consistent with all embodiments, modifications, alternative constructions, and equivalents thereto.

### DETAILED DESCRIPTION

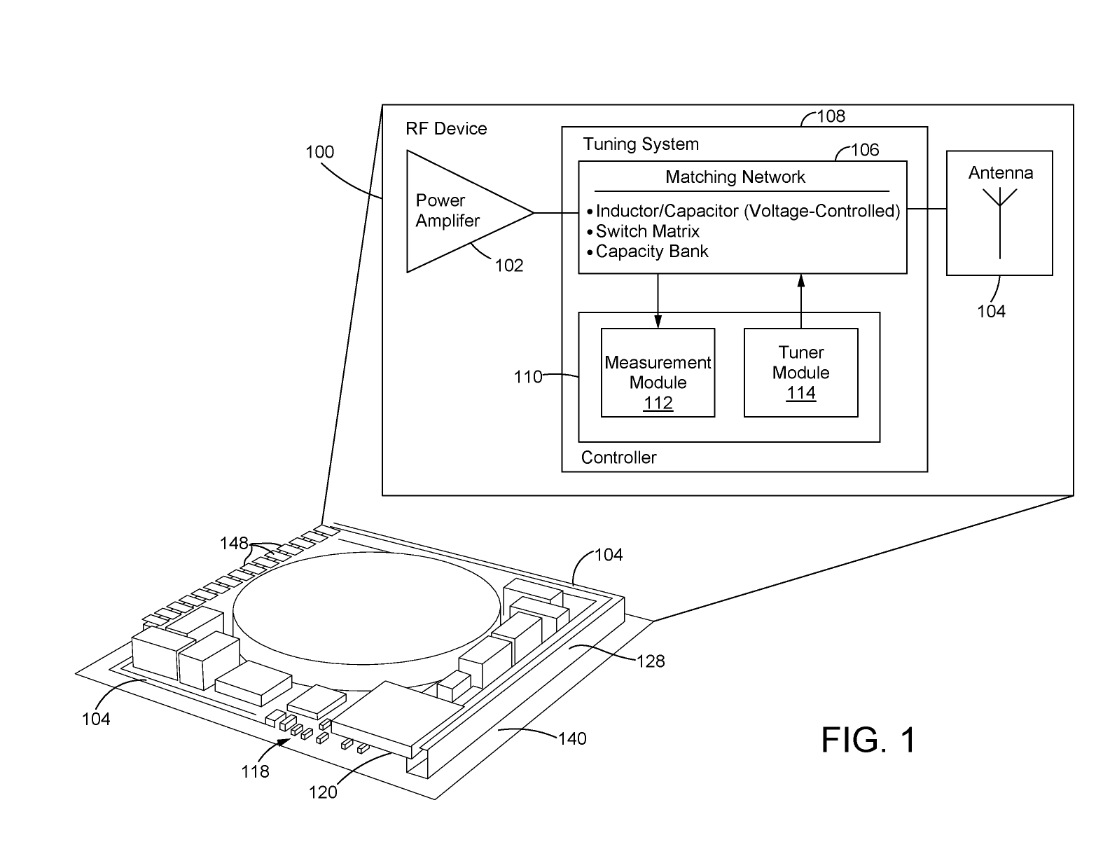

Referring to FIG. 1, one exemplary embodiment of a radio frequency (RF) device 100 is diagrammatically provided. As shown, the RF device 100 may generally enclose, among other things, a power amplifier 102, an antenna 104, and a matching network 106 that is in electrical communication with each of the power amplifier 102 and the antenna 104. More particularly, as is commonly understood in the relevant arts, the power amplifier 102 may supply an electrical current that is supplied to the antenna 104 through the matching network 106. Moreover, the matching network 106 may include a network of inductors, capacitors, resistors, and other electrical components configured to collectively match the effective impedance of the antenna 104, and to allow for more efficient and optimized radio performance. The RF device 100 may additionally be provided with a tuning system 108 which may be at least partially incorporated into or integrated with the matching network 106 of the RF device 100.

In particular, the tuning system 108 of FIG. 1 may include at least a controller 110 that is in electrical communication with one or more of the inductors, capacitors, or other electrical components of the matching network 106, and generally configured to dynamically optimize antenna matching during operation of the RF device 100. More specifically, the controller 110 may be implemented using any type of controller, microcontroller, processor, microprocessor, or other integrated circuit that can be programmed to adjust, modify, adapt or tune the effective impedance of the matching network 106 in response to detected changes in the counterpart impedance of the antenna 104. For instance, the controller 110 may be able to monitor for any changes in electromagnetic properties, such as transmission efficiency, and correct for adverse effects caused by frequency change, near field interference, or the like, which may be especially prevalent in miniaturized RF devices 100 with small antennas 104 as in the present disclosure.

The controller 110 of FIG. 1 may be preprogrammed or otherwise configured to operate according to predetermined algorithms, sets of logic instructions or code, designed to operate at least the tuning system 108. Furthermore, the controller 110 may be configured to function using one or more blocks of preprogrammed instructions or code, which may be generally categorized into, for example, a measurement module 112 and a tuner module 114. Although the measurement module 112 and the tuner module 114 may be implemented using a separate and/or dedicated controller 110, the measurement module 112 and the tuner module 114 may alternatively be implemented into an existing controller 110 that is configured to manage other operations of the RF device 100. Also, while only one arrangement of the tuning system 108 is depicted in FIG. 1, it will be understood that other arrangements and other techniques for implementing any one or more of the controller 110, the measurement module 112 and the tuner module 114 may be employed to provide comparable results.

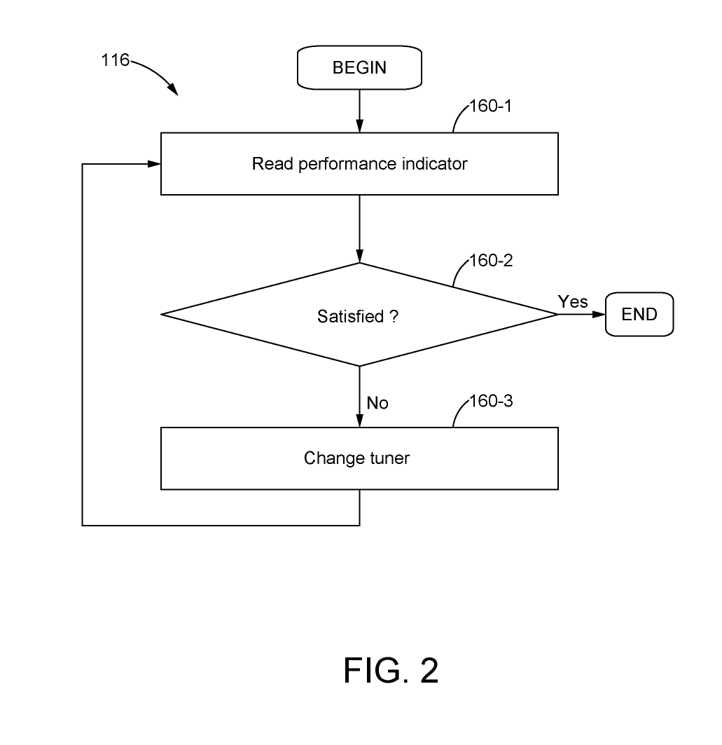

Turning now to FIG. 2, one exemplary method 116 of tuning antenna match, or for tuning the effective impedance of the matching network 106, is provided. One or more of the processes of the method 116 may be implemented using algorithms, instructions, logic operations, digital circuitry, analog circuitry, or combinations thereof. Moreover, the method 116 may be implemented and realized by monitoring and adjusting one or more electrical components or elements within the matching network 106. As shown in FIG. 2, the method 116 in block 116-1 may initially monitor a performance indicator, such as a voltage of the matching network 106. The voltage may be monitored at a point or location within the matching network 106 that is least likely to dissipate any noticeable power while most informative as to matching conditions. Furthermore, the monitoring point may be disposed where the exhibited voltage is near a maximum or a minimum value when matching conditions are optimized. Although different antenna designs may dictate different monitoring points, all tuning techniques may rely on a relationship between an observed voltage and match quality.

In block 116-2, the method 116 of FIG. 2 may determine whether the observed voltage is satisfactory, or whether further correction of the matching network 106 is desirable. For instance, the method 116 may determine whether tuning is warranted by gauging the voltage against predefined or predetermined values, by gauging differences between the actual voltage and expected voltage against predefined thresholds, or by using other techniques to assess the decrease in match quality in some quantifiable form. If the voltage suggests that the match quality is substantially unchanged, the method 116 may deem no tuning is necessary and continue monitoring the voltage per block 116-1. If, however, the voltage suggests that the match quality has substantially changed, the method 116 may deem that tuning is desirable and proceed to block 116-3 in order to adjust the effective impedance of the matching network 106 and to correct the match quality.

In general, the method 116 in block 116-3 of FIG. 2 may tune or adjust the effective impedance of the matching network 106 by adjusting one or more of the inductors, capacitors, or other electrical components within the matching network 106. The electrical components or the effective impedance thereof can be adjusted using any combination of techniques. For example, the effective impedance can be modified through control of voltage-controlled capacitors and/or inductors which may be provided within the matching network 106. The effective impedance can also be modified using a switch matrix, or a controllable array of switches configured to selectively enable or disable one or more connected capacitors or inductors according to a target impedance. Still further, the effective impedance can also be modified using control of an array or a bank of binary-scaled capacitors individually coupled between a point within the matching network 106 and a ground node.

As indicated above, the method 116 of FIG. 2 in block 116-3 may modify the effective impedance of the matching network 106 using any combination of techniques. The specific amount of adjustment to the impedance needed may also be determined in any number of different ways. The amount of desired adjustment may be determined based on a predetermined relationship between the detected change in voltage or match quality, the location of the monitoring point within the matching network 106, the specific adjustment technique used, and any other relevant factors. The resolution used in determining and/or adjusting impedance may be designed to be fine or coarse depending on the desired application. For instance, coarser techniques may rely less on complex adjustment mechanisms and more on a trial-and-error type of strategy to incrementally adjust the effective impedance through multiple iterations, whereas finer techniques may rely on more complex adjustment mechanisms upfront, but ultimately require less iterations to optimize antenna match due to better accuracy.

Once the method 116 in FIG. 2 adjusts the effective impedance of the matching network 106, the method 116 may return to block 116-1 to continue monitoring, subject to radio traffic, the voltage for any subsequent changes in match quality. In such ways, the method 116 may incrementally correct or improve the match quality until optimized and until the apparent impedance of the antenna 104 is substantially matched. It will be noted that the method 116, or the monitoring processes thereof, may be performed continuously or periodically at predefined intervals. Although the method 116 is illustrated in one possible sequence of processes, it will be understood that any two or more of the processes shown may be performed simultaneously or in other sequences without departing from the scope of the appended claims. Also, while only one arrangement of processes are shown in FIG. 2, it will be understood that other arrangements or variations may be similarly employed and still provide comparable results.

In alternative embodiments, the method 116 of FIG. 2, or one or more processes thereof, may operate to perform the monitoring and adjustment features in a collective fashion rather than in a continuous mode. To the extent allowed by the given application, for example, the method 116 may enable radio transmissions at certain power levels and frequencies. In one example, the method 116 may establish the adjustment feature in one setting, while employing the monitoring feature to measure voltage. During radio transmissions, for instance, the method 116 may first test several possible adjustment values, and search for the combination of adjustment values or settings which exhibit optimal match quality. The method 116 may then set or apply these values for further radio transmissions until further adjustments are necessary. The method 116 may also be configured to perform the adjustments during a preamble, or some other suitable period prior to transmission or reception, designed to minimize latencies between when adjustments are made and when the antenna 104 is in use. Other such variations can also be used to provide comparable results.

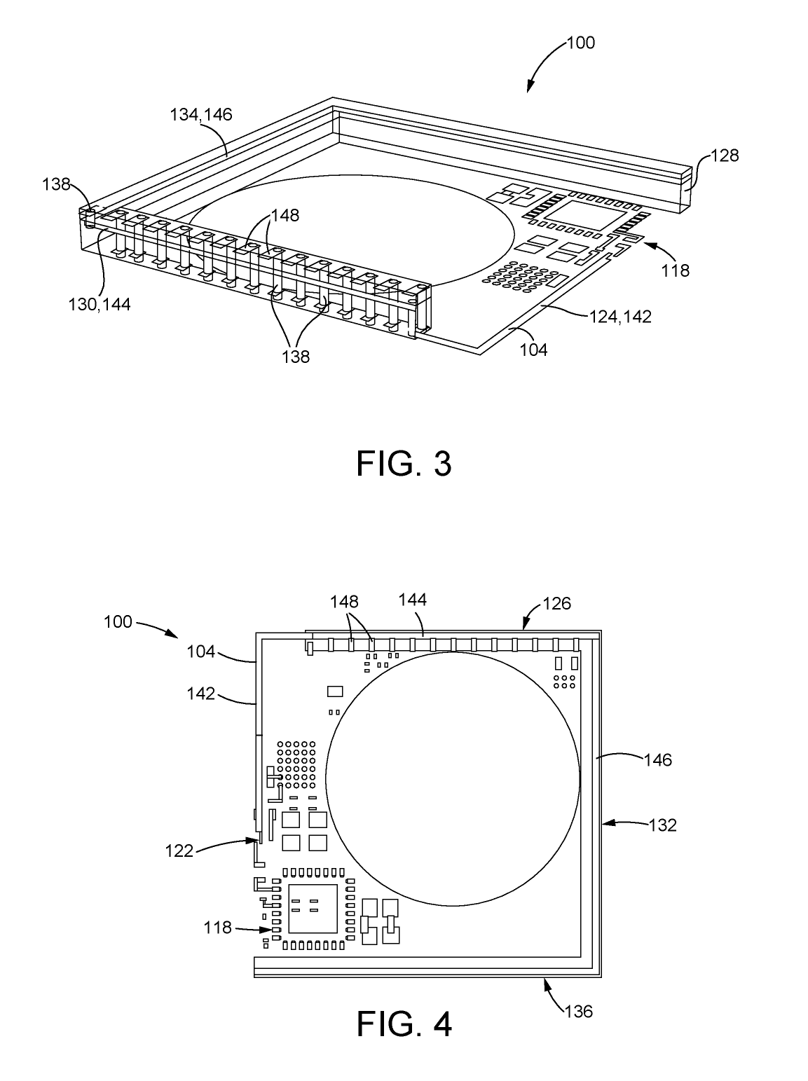

Referring now to FIGS. 3-7, one exemplary embodiment of an antenna 104 that may be used with the RF device 100 and the tuning system 108 of the present disclosure is provided. Although enlarged for clarity, the RF device 100 shown may encompass and enclose all of the power amplifier 102, antenna 104, matching network 106 and controller 110 of FIG. 1 in a substantially small and miniaturized package, such as having physical dimensions of approximately 19 mm×19 mm×2 mm. Furthermore, although significantly reduced in size, the RF device 100 may be able to retain effective and reliable radio performance by employing the design of the antenna 104 shown in FIGS. 3-7 in conjunction with the tuning system 108 and method 116 discussed above. Still further, although only one embodiment of the antenna 104 and the RF device 100 is depicted in FIGS. 3-7, other geometries, arrangements, sizes or scales may similarly operate to provide comparable results.

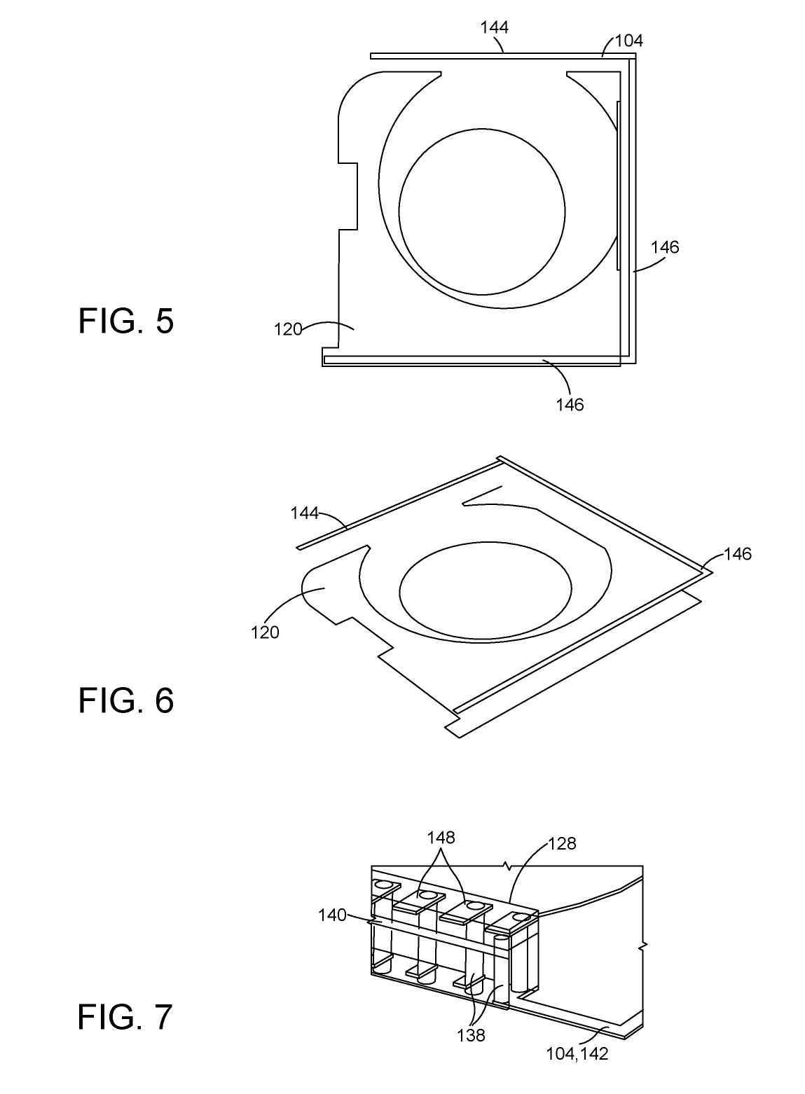

As disclosed in FIGS. 3-7, the RF device 100 may generally include a device circuit 118 that is electrically coupled to the antenna 104, both of which may be disposed in electrical communication with a partially underlying ground pattern 120. Among other components, the device circuit 118 may generally be composed of the power amplifier 102, matching network 106, the tuning system 108 or controller 110 thereof. The device circuit 118 may further include an independent power supply, such as a battery, and any other electrical component needed to realize the RF device 100 of the present disclosure. The ground pattern 120 may lie within a ground layer of the RF device 100 which generally defines a perimeter about the RF device 100 that is substantially traced by the antenna 104. As shown in FIG. 5, for example, the antenna 104 may be partly disposed along the perimeter, above the ground pattern 120, and partially disposed outside of the ground pattern 120 in a manner configured to allow for the largest possible antenna extension, retaining optimal efficiency and radio performance. The antenna 104 may also be disposed along the edges of the RF device 100 and configured to be multi-planar, or residing within multiple levels or layers of the RF device 100. Generally, the technique for designing an antenna 104 that is robust to changes in the immediate environment is a balancing act between making the effective antenna 104 as large as possible while protecting the antenna 104 from adverse influence from neighboring materials. The location of the antenna 104 and associated elements in selected dielectric materials proximate to the perimeter of the RF device 100 allows optimization of this balancing act.

As shown in FIG. 3, the antenna 104 may begin at a first edge 122 of the RF device 100 and at a lower or first layer 124 that is coincident with the ground pattern 120. The antenna 104 may continue along a portion of the first edge 122 and into a second edge 126 of the RF device 100 until the antenna 104 reaches a carrier body or laminate 128 partly through the second edge 126. Once at the laminate 128, the antenna 104 may be elevated into an intermediate or second layer 130, or effectively free space, for the remainder of the second edge 126, and once at a third edge 132 of the RF device 100, the antenna 104 may again be shifted into a third layer 134 of the laminate 128, and potentially remain in the third layer 134 for the remainder of the third edge 132 and a fourth edge 136 of the RF device 100, almost forming a full perimeter about the ground pattern 120. Additionally, as shown in FIG. 7, the antenna 104 may connect through the different layers of the laminate 128 and to an underlying printed circuit board (PCB) 140 using vertical interconnect access (VIA) connectors 138, or the like, which enable electrical conductivity therethrough. The locations of the different vertical shifts and the actual vertical displacements are parameters for optimization within practical constraints, rendering the approach for designing the antenna 104 quite flexible.

Accordingly, the antenna 104 shown in FIGS. 3-7 may comprise a ground level section 142, an intermediate section 144 and elevated sections 146, where the ground level section 142 is disposed on the ground pattern 120, the intermediate section 144 is shifted relative to the ground section 142 and the ground pattern 120, and one or more of the elevated sections 146 are shifted relative to the intermediate section 144. Furthermore, the ground level section 142 may be coupled to the device circuit 118, and the intermediate section 144 may be coupled to each of the ground level section 142 and the elevated section 146 through VIA connectors 138, or the like. The RF device 100 may further provide connector pads 148 disposed above, but separated from, one or more of the intermediate section 144 and the elevated section 146 of the antenna 104, such as by approximately 0.5 mm, or the like, so as to avoid coupling between the antenna 104 and the connector pads 146. Although the RF device 100 is shown on a rectangular PCB 140, other shapes and arrangements may also be used without departing from the scope of the appended claims.

The various geometric relationships presented herein between the antenna 104, the device circuit 118, and the ground pattern 120, among other things, serve to further optimize radio performance. In the embodiment shown in FIGS. 3-7, for instance, the general distance between the ground pattern 120 and the antenna 104, the ratio of the amount of the antenna 104 residing in effective free space or above ground pattern 120, and the general distance between the antenna 104 and the device circuit 118 of the RF device 100 may be collectively optimized to provide not only better efficiency for specific environments, but also better overall or average efficiency for dynamic conditions and environments that are otherwise susceptible to near field interference. Moreover, the antenna 104 shown in FIGS. 3-7, combined together with the adaptive monitoring and adjustment techniques provided by the tuning system 108 of FIG. 1 and the tuning method 116 of FIG. 2, enable extremely miniaturized and compact RF devices 100 that are not adversely affected by the miniaturization or compactness in terms of radio performance.

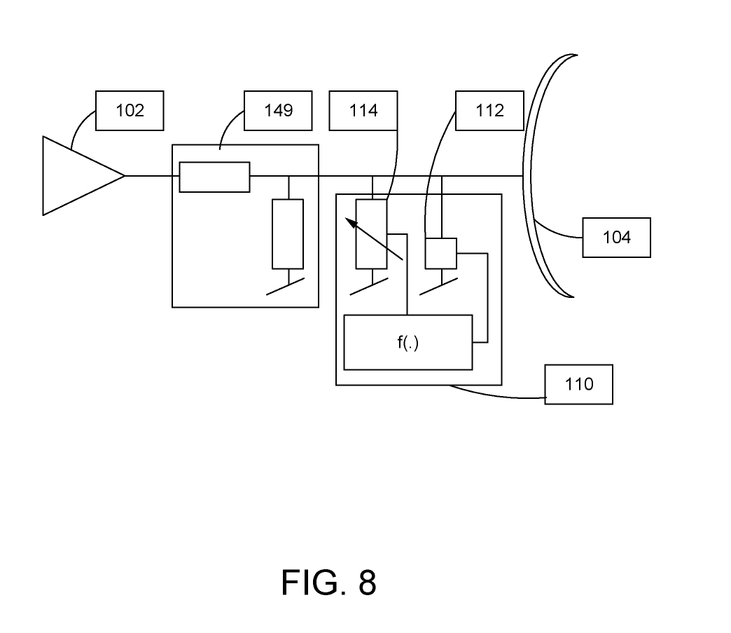

Further turning to FIG. 8, one exemplary embodiment of a matching network 106 with a measurement module 112 and a tuner module 114 is provided. In the embodiment shown, the tuner module 114 is depicted as a tunable ground connection. More specifically, a fixed matching circuit 150 may be inserted between the power amplifier 102 and the antenna 104, where the measurement module 112 and the tuner module 114 are also coupled. Other arrangements may be employed depending on the type of application given. For example, one arrangement may configure the fixed matching circuit 150 to be coupled toward or proximate to the antenna 104. In another arrangement, the fixed matching circuits 150 may be disposed on both sides, such as a first fixed matching circuit 150 disposed proximate to the power amplifier 102 on one side and a second fixed matching circuit 150 disposed proximate to the antenna 104 on the other side. In still another arrangement, one or more tuner modules 114 may be disposed in other locations relative to one or more of the measurement modules 112.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

What is claimed is:

1. A method of tuning antenna match, the method comprising:
providing a matching network of inductors and capacitors configured to match an impedance of an antenna;
monitoring a voltage of the matching network; and
adjusting an effective value of one or more of the inductors and the capacitors of the matching network when the voltage indicates a decrease in match quality.

2. The method of claim 1, wherein one or more of the inductors and the capacitors are voltage-controlled and have variable effective impedance, the effective impedance being adjusted when the voltage indicates a decrease in match quality.

3. The method of claim 1, wherein the matching network includes a switch matrix configured to selectively couple one or more of the inductors and the capacitors to the antenna, the switch matrix being adjusted when the voltage indicates a decrease in match quality.

4. The method of claim 1, wherein the matching network includes a bank of binary scaled capacitors configured with variable effective capacitance, the bank of binary scaled capacitors being adjusted when the voltage indicates a decrease in match quality.

5. The method of claim 1, wherein the voltage is monitored at a point within the matching network between an output of an associated power amplifier and an input of the antenna.

6. The method of claim 1, wherein the voltage is monitored at a point configured to observe a voltage that is at one of a maximum voltage and a minimum voltage when match quality is optimal.

7. The method of claim 1, wherein the match quality is determined based on a predefined relationship between the voltage and the match quality.

8. A system for tuning a radio frequency (RF) device having a power amplifier and an antenna, the tuning system comprising:
a matching network coupled between the power amplifier and the antenna; and
a controller having a measurement module and an tuner module in communication with the matching network, the measurement module being configured to monitor a voltage of the matching network, and the tuner module being configured to adjust an effective value of the matching network when the voltage indicates a decrease in match quality.

9. The system of claim 8, wherein the matching network includes one or more of inductors and capacitors having variable effective impedance, the tuner module being configured to adjust the effective impedance when the voltage indicates a decrease in match quality.

10. The system of claim 8, wherein the matching network includes a switch matrix selectively coupling one or more of inductors and capacitors to the antenna, the tuner module being configured to adjust the switch matrix when the voltage indicates a decrease in match quality.

11. The system of claim 8, wherein the matching network includes a bank of binary scaled capacitors configured with variable effective capacitance, the tuner module being configured to adjust the bank of binary scaled capacitors when the voltage indicates a decrease in match quality.

12. The system of claim 8, wherein the measurement module is configured to monitor voltage at a point configured to observe a voltage that is at one of a maximum voltage and a minimum voltage when match quality is optimal.

13. The system of claim 8, wherein the measurement module is configured to determine the match quality based on a predefined relationship between the voltage and the match quality.

14. A radio frequency (RF) device, comprising:
a ground layer defining a perimeter thereabout and having a ground pattern therein;
a device circuit disposed on the ground pattern and within the perimeter; and
an antenna coupled to the device circuit and disposed at least partially along the perimeter about the ground layer.

15. The RF device of claim 14, wherein the antenna includes at least one section that is disposed outside of the perimeter, and at least one section that is disposed along the perimeter and above the ground pattern.

16. The RF device of claim 14, wherein the antenna is multi-planar and includes at least one section within the ground layer and at least one section elevated relative to the ground layer.

17. The RF device of claim 14, wherein the antenna includes a ground section, an intermediate section and an elevated section, the ground section being disposed on the ground layer, the intermediate section being shifted relative to the ground section and the ground layer, the elevated section being shifted relative to the intermediate section.

18. The RF device of claim 17, wherein the ground section is coupled to the device circuit, and the intermediate section is coupled to each of the ground section and the elevated section through one or more vertical interconnect access (VIA) connectors.

19. The RF device of claim 17, further comprising connector pads disposed above one or more of the intermediate section and the elevated section of the antenna.

20. The RF device of claim 14, further comprising a rectangular printed circuit board (PCB) upon which the ground layer is installed, the antenna at least partially extending along all four sides of the rectangular substrate.
